(19) United States
(12) Patent Application Publication
(10) Pub. No.: US 2011/0308881 A1
(43) Pub. Date: Dec. 22, 2011

(54) Driver assistance device for a backhoe loader vehicle

(76) Inventors: Louis W. Cappuccio, Hammonton, NJ (US); Michael Cappuccio, Hammonton, NJ (US)

(21) Appl. No.: 12/803,084

(22) Filed: Jun. 18, 2010

(51) Int. Cl. G05G 1/54

(52) U.S. Cl. 180/320

(57) ABSTRACT

A drive assistance device for a backhoe loader vehicle has an elongated bar member having a hook or post component at its lower end which is configured to be placed around or adjacent to the directional control pedal of a hydrostatically controlled backhoe loader vehicle. The elongated bar member has a handle at its upper end to allow the vehicle operator to grasp the bar member. When the lower end of the bar member is connected to the pedal, the bar member extends up to the operator, who can then easily and safely control the movement of the pedal, allowing it to be placed in neutral to maintain the vehicle in a stationary position while digging is being done, and to be moved ahead, while safely operating the steering wheel, to move the vehicle in the appropriate forward direction.

### FIELD OF THE INVENTION

This invention relates to a device which allows the operator of a hydrostatically controlled backhoe loader type vehicle to easily and safely control the vehicle during backhoe digging operations.

### BACKGROUND OF THE INVENTION

Backhoe loader vehicles are important and functionally necessary pieces of machinery which are utilized for a variety of purposes. One of the most common uses for such vehicles is for scooping out holes, trenches, and similar digging operations. Yet it is critical that these vehicles be readily moveable during such operations. For example, when digging elongated trenches, the backhoe loader vehicle must be constantly moved in a forward direction, to allow the vehicle to scoop out dirt along the full length of the trench behind the vehicle. Unfortunately, the need to operate a backhoe loader for digging, for moving the vehicle forward, and for then repeating this process over and over again, presents a number of important safety issues.

Trench digging operations require the operator of a backhoe loader to be positioned on the vehicle's seat such that he faces backward while using the backhoe component for digging. When it is necessary to move the vehicle slightly forward to dig out the next section of the trench, the operator must turn and face forward in the direction of travel. In older to do this safely, the operator must leave the cab of the vehicle, rotate the vehicle's seat 180°, climb back into the vehicle, and then move the vehicle the appropriate distance forward. The operator must then again leave the vehicle, rotate the seat back so that it is rearward facing, re-enter the vehicle, and continue with the backhoe digging operations. The steps of this procedure must be repeated numerous times while the trench, sometimes quite long, is being dug.

As a practical matter, operators of backhoe loaders in the field seldom, if ever, take the time to repeatedly leave their vehicles and reposition the seating so that they are at all times safely facing the direction in which they are working or driving. Instead, once a section of a trench is dug, the common practice is for the operator to remain in the rearward facing seat of the vehicle and reach down to the hydrostatically controlled directional pedal on the floor of the vehicle, while attempting to steer in a forward direction. This practice, while routine, is very unsafe. Since the driver/operator is not in the proper position to drive and steer the vehicle ahead, he has limited and restricted maneuverability and lack of control.

Even if the operator follows the recommended practice of leaving the cab of the vehicle each time he needs to change the seat orientation, there is the enhanced risk that the operator will slip, or otherwise be injured while repeatedly entering and re-entering the vehicle, during the many times the vehicle must be moved.

### SUMMARY OF THE INVENTION

It is thus the object of the present invention to provide a driver assistance device for a backhoe loader vehicle having hydrostatic forward and reverse directional pedal controls, which permits the driver to operate the vehicle safely, while at all times remaining seated in the vehicle, with the vehicle's seat facing rearward.

This object is accomplished by the present invention, a driver assistance device comprising an elongated bar member having a hook or post component at its lower end which is configured to be placed around or adjacent to the directional control pedal of a hydrostatically controlled backhoe loader vehicle. The elongated bar member has a handle at its upper end to allow the vehicle operator to grasp the bar member. When the lower end of the bar member is connected to the pedal, the bar member extends up to the operator, who can then easily and safely control the movement of the pedal, allowing it to be placed in neutral to maintain the vehicle in a stationary position while digging is being done, and to be moved ahead, while safely operating the steering wheel, to move the vehicle in the appropriate forward direction.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the components of the driver assistance device of the present invention.

FIG. 2 shows the components of an alternate embodiment of the driver assistance device of the present invention.

FIG. 3 is an elevation view of the embodiment of the driver assistance device of the present invention shown in FIG. 1.

FIG. 4 is an elevation view of the embodiment of the driver assistance device of the present invention, as shown in FIG. 2.

FIG. 5 shows the embodiment of the driver assistance device of the present invention shown in FIGS. 1 and 3 in position on a directional control pedal.

FIG. 6 shows the embodiment of the driver assistance device of the present invention shown in FIGS. 2 and 4 in position on an alternate directional control pedal.

FIG. 7 depicts the driver assistance device of the present invention in use in operating a backhoe loader vehicle.

FIG. 8 depicts the operation of a backhoe loader vehicle without the use of the driver assistance device of the present invention.

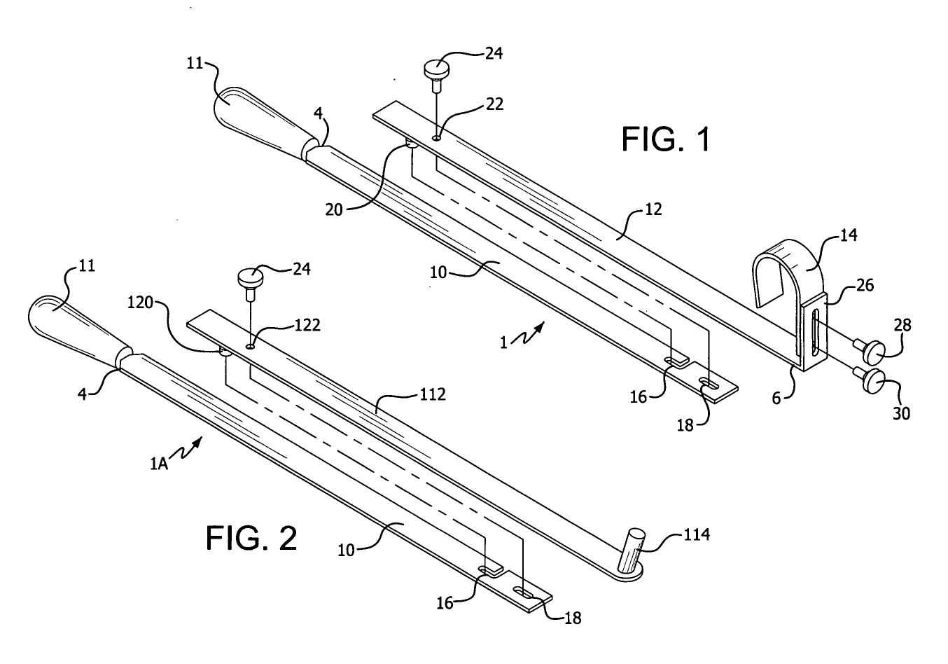

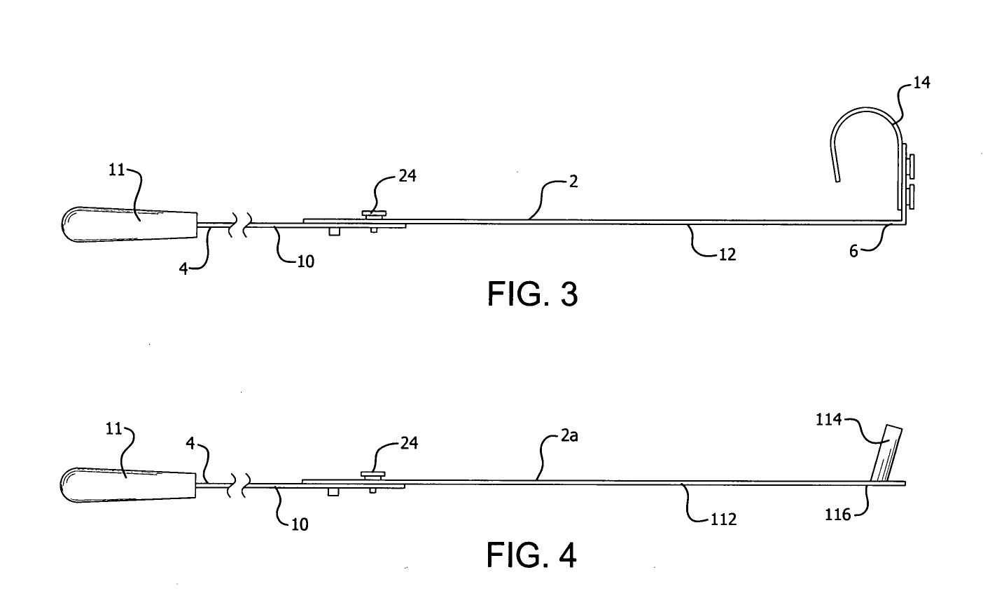

### DETAILED DESCRIPTION OF THE INVENTION

Driver assistance device 1 comprises elongated bar member 2 having upper end 4 and lower end 6. Bar member 2 itself consists of upper bar element 10 with handle 11 at upper end 4, and lower bar element 12. The lower end of bar element 10 has internal notch 16 and elongated opening 18. The upper end of bar element 12 has upstanding support tab 20 and threaded hole 22. The lower end of bar element 10 is positioned on the upper end of bar element 12 such that support tab 20 is located within notch 16 and opening 18 is over threaded hole 22. Screw connection member 24 is inserted into opening 18 and then screwed tightly into threaded hole 22 in order to secure bar element 10 to bar element 12.

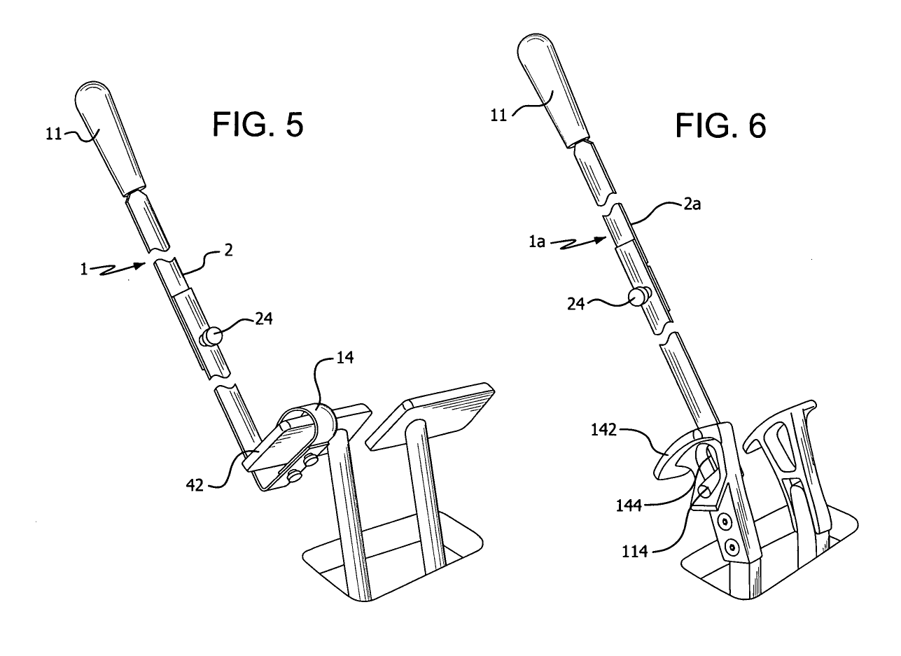

Lower end 6 of bar member 2, the lower end of bar element 12, comprises hook shaped component 14. Hook component 14 can be secured to bar element 12 via connection to upstanding plate 26 by screw connection members 28 and 30, or it can be formed as an integral component extending from lower end 6. In both instances hook component 14 is configured to substantially circumscribe the pedal of a hydrostatic backhoe loader vehicle which controls forward and reverse movement of the vehicle. See FIG. 5.

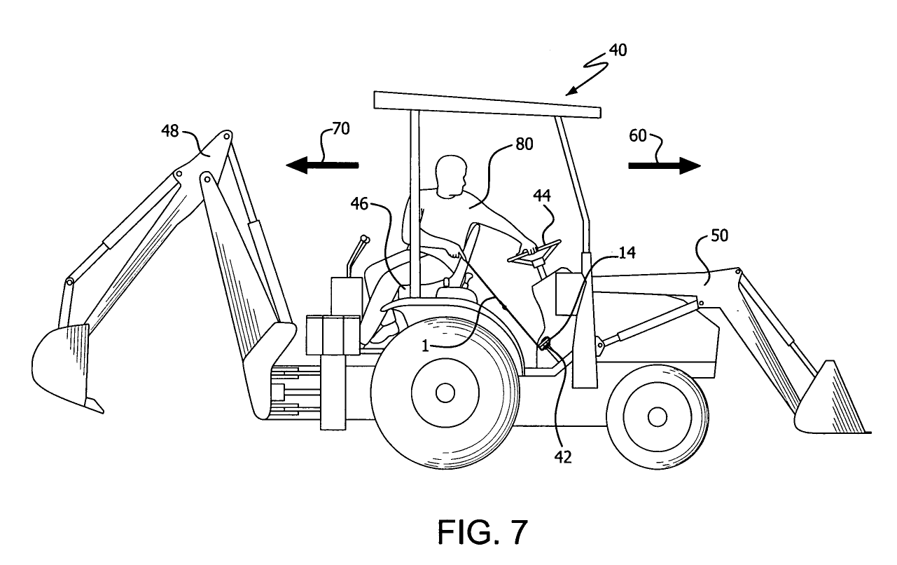

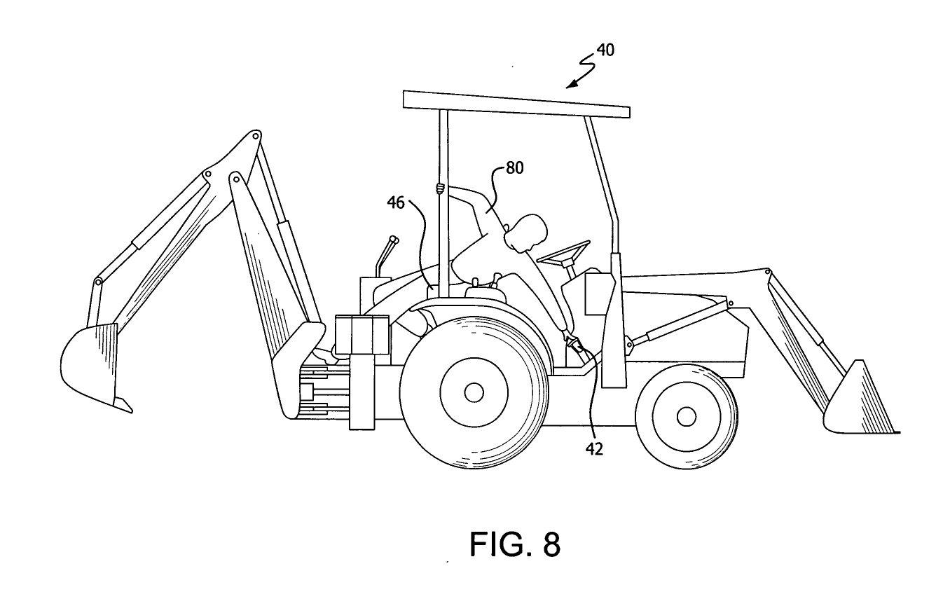

Driver assist device 1 is designed to be used on backhoe loader vehicle 40 having backhoe component 48 attached at the vehicle's back end and loader/shovel component 50 attached at its front end. Vehicle 40 utilizes vehicle directional control pedal 42 to operate a hydrostatic system. The system provides that when pedal 42 is pushed down/forward, vehicle 40 moves in a forward direction 60. When pedal 42 is pulled up/back, vehicle 40 moves in reverse direction 70. Vehicle 40 remains in neutral when pedal 42 is in a mid-position. Steering wheel 44 operates to turn vehicle 40, whether it is moving in the forward or reverse direction. Operator seat 46 is designed to rotate in order to face forward when vehicle 40 is to be moved in forward direction 60 and to face backward when the vehicle is to be moved in reverse direction 70. FIGS. 7 and 8 show vehicle 40 with its seat 46 facing backward.

In operation, for instance when backhoe component 48 of vehicle 40 is used to dig a trench, the vehicle operator 80 is in position in seat 46, facing backwards. When digging is completed on one section of the trench, vehicle 40 must be moved forward, in the proper direction, so that the next section of the trench can be dug. In order to move vehicle 40 forward, safety dictates that vehicle operator 80 leave the vehicle, rotate seat 46 180°, remount the seat, and, while steering by turning steering wheel 44, push down on pedal 42 to move the vehicle in the proper direction. Operator 80 then must place pedal 42 in its neutral position, once again leave vehicle 40, rotate seat 46 back to its rear facing position, remount the seat, and continue digging the trench with backhoe component 48. This process must be repeated until the trench is completely dug out.

As a practical matter, however, operators in the field seldom, if ever, take the time to repeatedly leave their vehicles and reposition seating. Instead, once a section of a trench is dug, the common practice is for the operator 80 to remain in the rearward facing seat 46, and reach down to pedal 42 while attempting to steer vehicle 40 in a forward direction. See FIG. 8. This is an unsafe practice, for obvious reasons, e.g. limited and restricted maneuverability, lack of control of directional vehicle movement, etc. Driver assistance device 1 of the present invention provides a safe alternative.

In use, hook shaped component 14 of driver assistance device 1 is positioned around pedal 42 of vehicle 40, so that bar member 2 extends up towards rear facing seat 46, as seen in FIGS. 5 and 7. Operator 80 can easily and readily hold onto handle 11 of driver assistance device 1, while remaining seated and facing backwards in vehicle 40. When vehicle 40 must be moved forward, operator 80 can simply push down on driver assist device 1, which forces pedal 42 down, and turn his head or body slightly to easily and safely use steering wheel 44 to steer the vehicle. See FIG. 7.

When vehicle 40 is moved forward and properly positioned, bar member is simply pulled up to place pedal 42 into its neutral position and operator 80 can then once again turn his attention to using backhoe component 48 to continue the digging operation. In this manner, operator 80 never has to leave seat 46, but can still safely conduct digging operations.

While drive assistance device 1 with hook component 14 can be used on the majority of backhoe loader vehicles, some vehicles utilize a directional control pedal with a configuration which is not conducive to the hook component. The pedals on these vehicles have mid-section openings. For these vehicles, driver assist device 1a is provided in which bar element 12 is replaced by bar element 112 having post component 114 on lower end 116 in lieu of hook component 14 of bar element 12. See FIGS. 2 and 4. Bar element 112 is connected to bar element 10 in the same manner in which bar element 12 is connected to bar element 10 to form elongated bar member 2a; i.e. the upper end of bar element 112 has an upstanding support tab 120 which is positioned within notch 16 of bar element 10 and threaded hole 122 into which screw connection member 24, having been positioned within opening 18, is screwed.

Post component 114 is configured to be inserted into opening 144 of pedal 142, as seen in FIG. 6. Operation of the vehicle having pedal 142 with drive assistance device la is the same as previously described with regard to its use with a vehicle having pedal 42.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A driver assistance device for a backhoe loader vehicle having adjustable rearward and forward facing operator seating and a vehicle direction control pedal, said device comprising:
an elongated bar member having upper and lower ends;
means at the lower end of the bar member for removeably connecting the bar member to the vehicle pedal; and
handle means at the upper end of the bar member for allowing a vehicle operator to hold on to the upper end of the bar member and, by moving the device forward and back, to control the forward and rearward movement of the vehicle while, at all times, remaining seated in a rearward facing position in the vehicle.

2. A driver assistance device as in claim 1 wherein the means for removeably connecting the bar member to the vehicle pedal comprises a hook shaped component configured to substantially circumscribe the vehicle pedal.

3. The driver assistance device as in claim 1 wherein the means for removeably connecting the bar member to the vehicle pedal comprises a post configured to be inserted adjacent to the vehicle pedal.

4. The driver assistance device as in claim 1 wherein the bar member comprises two bar elements and attachment means for removeably securing the bar elements.

5. The driver assistance device as in claim 4 wherein one of the bar elements comprises a hook shaped component configured to substantially circumscribe the vehicle pedal.

6. The driver assistance device as in claim 4 wherein one of the bar elements comprises a post configured to be inserted adjacent to the vehicle pedal.

7. The driver assistance device as in claim 1 wherein the bar member comprises an upper bar element, a lower bar element with a hook shaped component configured to substantially circumscribe the vehicle pedal, a second bar element comprising a post configured to be inserted adjacent to the vehicle pedal, and attachment means for interchangeably securing the upper bar member to the first bar element or the second bar element.

8. A backhoe loader vehicle comprising:
adjustable rearward and forward facing operator seating;
a vehicle direction control pedal;
an elongated bar member having upper and lower ends;
means at the lower end of the bar member for removeably connecting the bar member to the vehicle pedal; and
handle means at the upper end of the bar member for allowing a vehicle operator to hold on to the upper end of the bar member and, by moving the device forward and back, to control the forward and rearward movement of the vehicle while, at all times, remaining seated in a rearward facing position in the vehicle.

9. A driver assistance device as in claim 8 wherein the means for removeably connecting the bar member to the vehicle pedal comprises a hook shaped component configured to substantially circumscribe the vehicle pedal.

10. The driver assistance device as in claim 8 wherein the means for removeably connecting the bar member to the vehicle pedal comprises a post configured to be inserted adjacent to the vehicle pedal.

11. The driver assistance device as in claim 8 wherein the bar member comprises two bar elements and attachment means for removeably securing the bar elements.

12. The driver assistance device as in claim 11 wherein one of the bar elements comprises a hook shaped component configured to substantially circumscribe the vehicle pedal.

13. The driver assistance device as in claim 11 wherein one of the bar elements comprises a post configured to be inserted adjacent to the vehicle pedal.

14. The driver assistance device as in claim 8 wherein the bar member comprises an upper bar element, a lower bar element with a hook shaped component configured to substantially circumscribe the vehicle pedal, a second bar element comprising a post configured to be inserted adjacent to the vehicle pedal, and attachment means for interchangeably securing the upper bar member to the first bar element or the second bar element.
